(19) United States
(12) Patent Application Publication
(10) Pub. No.: US 2026/0037255 A1
(43) Pub. Date: Feb. 5, 2026

(54) ARTIFACT SOURCE CODE IDENTIFICATION

(71) Applicant: Oracle International Corporation, Redwood Shores, CA (US)

(72) Inventors: Benjamin SELWYN-SMITH, Brisbane (AU); Behnaz HASSANSHAHI, Brisbane (AU)

(73) Assignee: Oracle International Corporation, Redwood Shores, CA (US)

(21) Appl. No.: 18/789,651

(22) Filed: Jul. 30, 2024

(51) Int. Cl. G06F 8/71

(52) U.S. Cl. CPC G06F 8/71

(57) ABSTRACT

Artifact source code identification includes obtaining an artifact version identifier of an artifact in an artifact repository, generating, by a fuzzy regular expression generator, an artifact version identifier regular expression from the artifact version identifier for the artifact version, and processing, with the artifact version identifier regular expression, tags in a commit repository to select a subset of the tags. Artifact source code identification further includes selecting a top matching tag from the subset and obtaining a commit corresponding to the top matching tag.

### BACKGROUND

Software development includes developers writing new source code that uses libraries. After creating the source code, the source code may be compiled and linked with the libraries to create bytecode (binary code) that is the executable software. The binary code may be made up of smaller components such as object files, modules, or classes. At this stage, the bytecode is not easily readable by a human.

For large software projects, many libraries and library versions may be used in a single software project. Further, the libraries and library versions may change over time as new versions of the software are created. Similarly, multiple developers may modify the software code on an ad hoc and dynamic basis and inconsistently update the tags that identify the source code corresponding to the libraries incorporated into a program. The above aspects of software development may cause challenges in tracking the libraries and library versions that are in the software. Correspondingly, challenges may exist in determining whether security vulnerabilities exist in the software because of the libraries, determining whether outdated versions or libraries are used, or performing other analysis.

### SUMMARY

In general, in one aspect, one or more embodiments relate to a method that includes obtaining an artifact version identifier of an artifact in an artifact repository, generating, by a fuzzy regular expression generator, an artifact version identifier regular expression from the artifact version identifier for the artifact version, and processing, with the artifact version identifier regular expression, tags in a commit repository to select a subset of the tags. The method further includes selecting a top matching tag from the subset and obtaining a commit corresponding to the top matching tag.

In general, in one aspect, one or more embodiments relate to a system that includes at least one computer processor, a fuzzy regular expression generator, and a comparator. The fuzzy regular expression generator is configured to execute on the at least one computer processor to perform first operations that include obtaining an artifact version identifier of an artifact in an artifact repository and generating an artifact version identifier regular expression from the artifact version identifier for the artifact version. The comparator is configured to execute on the at least one computer processor to perform second operations that include processing, with the artifact version identifier regular expression, tags in a commit repository to select a subset of the tags, selecting a top matching tag from the subset, and obtaining a commit corresponding to the top matching tag.

In general, in one aspect, one or more embodiments relate to a non-transitory computer readable medium comprising computer readable program code for causing a computer system to perform operations including obtaining an artifact version identifier of an artifact in an artifact repository, generating, by a fuzzy regular expression generator, an artifact version identifier regular expression from the artifact version identifier for the artifact version, and processing, with the artifact version identifier regular expression, tags in a commit repository to select a subset of the tags. The operations further include selecting a top matching tag from the subset and obtaining a commit corresponding to the top matching tag.

Other aspects of one or more embodiments will be apparent from the following description and the appended claims.

### BRIEF DESCRIPTION OF DRAWINGS

FIG. 1 shows a system for artifact source code identification in accordance with one or more embodiments.

FIG. 2 shows a flowchart for artifact source code identification in accordance with one or more embodiments.

FIG. 3 shows a flowchart for generating an artifact version identifier regular expression in accordance with one or more embodiments.

FIG. 4 shows an example of artifact version identifier regular expression in accordance with one or more embodiments.

FIG. 5 shows an example of selecting an artifact version identifier in accordance with one or more embodiments.

FIG. 6 shows an example of selecting an artifact version identifier in accordance with one or more embodiments.

FIG. 7A and FIG. 7B show an example of a computing system in accordance with one or more embodiments.

Like elements in the various figures are denoted by like reference numerals for consistency.

### DETAILED DESCRIPTION

In general, embodiments are directed to identifying commits that correspond to software artifacts in target software. Generally, an artifact is a software project that may be linked to the target software. An example of an artifact is a library. Multiple versions of the artifact may exist. Each version of an artifact may be identified by an artifact version identifier. The artifact version identifier may be associated with the target software as part of identifying the components of the target software.

Artifacts are generated from commits to source code. A commit is a specific snapshot of changes made to one or more files in a repository. A commit may be made with a version control system and serves as a record of modifications to the source code at a particular point in time. For example, a set of commits may track changes to the source code file over time. The changed source code may be compiled to generate a new artifact version of the artifact. By performing a security analysis of the source code at the time of the commit, the security analysis may identify any security vulnerabilities in the target software caused by the artifact version corresponding to the commit.

Commits may each be associated with a tag identifying the commit. Thus, the artifact version identifier and the tag of the commit should match. However, in many cases, the tag of the commit is different than an expected tag. As such, the artifact version identifier and the tag often do not match. For example, artifact version identifiers may have different delimiters, different version characters, extraneous suffixes and prefixes, or version parts. Similarly, tags may also have variations from the artifact version identifiers. With the number of software artifacts and a number of versions of software artifacts, separately identifying each commit corresponding to various artifact version identifiers of artifact versions in the target software is infeasible.

One or more embodiments are directed to a multistage process. In a first stage, an artifact version identifier regular expression is generated from an artifact version identifier. The artifact version identifier regular expression is automatically generated to identify variations of tags that correspond to the commit that generated the artifact version. The artifact version identifier regular expression is applied to the tags to identify a subset of matching tags. From the subset of matching tags, the tags are sorted based on a scoring system and a tag is selected as being the matching tag. The commit corresponding to the matching tag is identified as corresponding to the artifact version included in the target software.

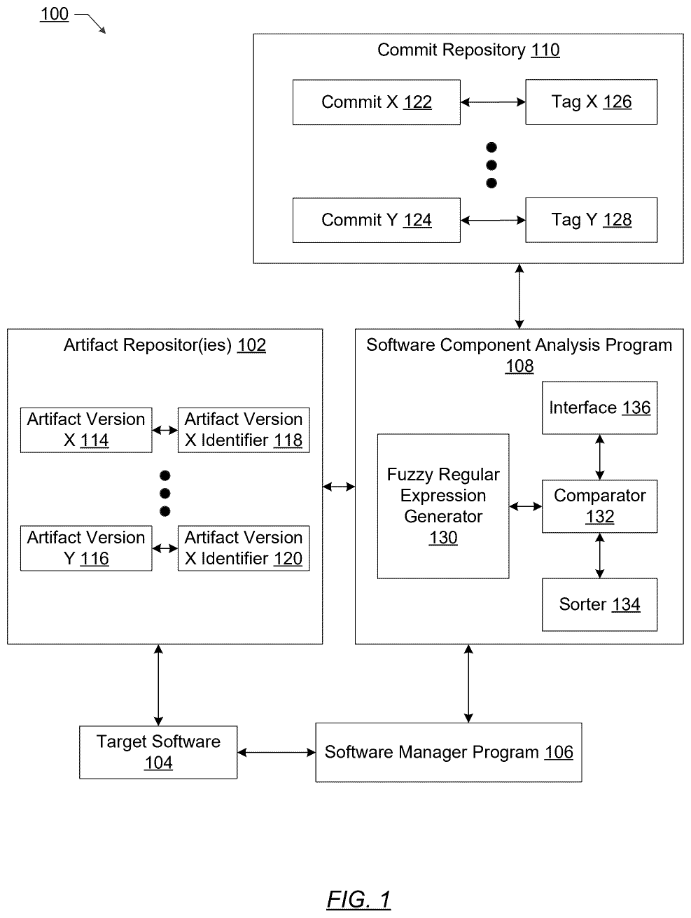

Turning to the Figures, FIG. 1 shows a diagram of a system in accordance with one or more embodiments. As shown in FIG. 1, the system (100) includes or is connected to one or more artifact repositories (102). In general, a repository is any type of storage unit and/or device (e.g., a file system, database, data structure, or any other storage mechanism) for storing data. A repository may include multiple different, potentially heterogeneous, storage units and/or devices.

An artifact repository (102) is a repository that has software artifacts. For example, the artifact repository (102) may be one or more web servers or other devices that store software artifacts (i.e., artifact). An artifact is a collection of data and programming code that is used to develop other software programs. For example, artifacts may include configuration data, documentation, software code in the form of pre-written and compiled classes, values, and other software resources that may be used by target software. In one or more embodiments, the artifacts are open-source libraries, which may be distributed through centralized hubs of the artifact repositories (102).

An artifact may have multiple versions (i.e., artifact version) (e.g., artifact version X (114), artifact version Y (116)). Between versions of an artifact, different parts of the artifact may change, and different parts may be the same as in other artifact versions of the same artifact. For example, classes may be added, removed, modified between versions, while some of the classes may be the kept unmodified between versions.

Each artifact version (e.g., artifact version X (114), artifact version Y (116)) is associated with a corresponding artifact version identifier (e.g., artifact version X identifier (118), artifact version Y identifier (120)) that uniquely identifies the artifact version. For example, the artifact version identifier may be formed of a triple having a group name, an artifact name, and a version identifier. The group name may be a name of a software group (e.g., company or department in a company, or other collection of developers) that develops the artifact. The artifact name is the unique identifier of the artifact within the group. The version identifier is the unique version identifier of the artifact version amongst the versions of the same artifact. Other naming schemes for artifacts may be used without departing from the scope of the claims.

Continuing with FIG. 1, target software (104) is configured to use one or more artifact repositories (102). Use may be based on a linkage or reference within the source code with the artifact in the artifact repository (102). Target software (104) is a program, enterprise software, or other collection of software that has at least a portion that is the target of analysis. Target software may be written in source code and compiled to binary code. Target software (104) may include one or more artifact versions of the same artifacts and one or more artifacts. With a complicated software development process, the target software (104) may include old versions of one or more artifacts. Further, the artifact and artifact versions may not be identifiable in the target software (104). For example, the computing system (not shown) having the target software (104) may only have the binary code format of at least the portion of the target software being analyzed. A separate listing of artifact version identifiers may be associated with the target software.

A commit repository (110) is a repository that stores commits (e.g., commit X (114), commit Y (116)). A commit is a specific snapshot of changes made to one or more source code files in a repository. For example, a commit may include a hash value, author information, a commit message, a changeset, one or more parent commits, etc. The hash value may be a unique identifier for the commit, which may be generated from the contents of the commit using a cryptographic hash function. The author information may include the name and email address of the person who created the commit to track who made the changes. The commit message is a brief description of the changes included in the commit written using natural language and stored as text. A changeset includes the changes made to the files of the repository for the software project, which may include additions, deletions, modifications, etc., to files and directories. For example, the changeset may indicate the changes to the source code. In an embodiment, parent commits are references to the previous commits from which the current commit originated, to provide a chronological link and version history. Thus, a set of commits with the parent commits may track changes to the source code file over time.

The commit (e.g., commit X (114), commit Y (116)) may be uniquely related to a tag (e.g., tag X (126), tag Y (128)). The tag is a unique identifier of the commit. The tag may include one or more of the same components as the artifact version identifiers in the same or different format as the corresponding artifact version identifier. The following are examples of differences that may be found between the artifact version identifier and the corresponding tag. The number of version parts may be different. For example, a version identifier may be composed of more or less than three parts (e.g., generally within the range of one to five). Further, the tag may have additional suffix parts that are not present in the related artifact version identifier. Conversely, the artifact version identifier may have additional suffix parts that are not present in the corresponding tag. Additionally, extra text may be added to prefix in the artifact version identifier or in the tag. The extra text may represent the artifact name, or relate to other repository properties, such as releases or milestones. For example, the extra text may precede the version identifier with a hyphen. Further, different delimiters may be used between the artifact version identifier and the tag and between different parts of the artifact version identifier or tag. For example, the delimiters may be periods, underscores, hyphens, and alphabetic characters. Various version characters may be used. The version character is a single character before the version, such as a “v”, “r”, or “c”. The variations between the artifact version identifier and the tag may cause challenges in identifying the corresponding commit for the artifact version.

FIG. 1 may include a software management program (106). A software management program (106) is a program that performs at least one management task of the target software (104). For example, the software management program (106) may be configured to detect and address security vulnerabilities in target software (104). As another example, the software management program (106) may be a tool that updates software or provides recommendations for updating software. The software management program (106) is connected to a software component analysis program (108).

The software component analysis program (108) is a software tool that is configured to identify the artifact version and the corresponding commit in target software (104) based on a request. The request may have the artifact version identifier or an identifier of the target software (104). The software component analysis program (108) may be connected to the artifact repository (102), the commit repository (102), and/or to other components of the system.

The software component analysis program (108) includes a fuzzy regular expression generator (130), a sorter (134), an interface (136), and a comparator (132). A fuzzy regular expression generator (130) is a regular expression generator that generates regular expressions for fuzzy matching rather than exact matching. Namely, the fuzzy regular expression generator (130) is software that generates regular expressions to identify matches. The matches are fuzzy matches that have variations between the matching portions of the tags and outside of the matching portions of the tags. Thus, the fuzzy regular expression allows for each of the variations between the artifact version identifier and the tag. Further, the fuzzy regular expression is specific to the artifact version identifier. As such, the fuzzy regular expression generator (130) is an artifact version identifier regular expression.

The sorter (134) is software configured to sort resulting matching tags. Sorting the matching tags identifies which tags are more likely to match the artifact identifier. In one or more embodiments, the sorter (134) is configured to score the matching tags. Scoring the matching tags identifies a score for each matching tag. An example of a sorter (134) is an algorithmic based sorter and a binary classifier model, such as a machine learning based model. For example, an algorithmic based sorter may apply one or more algorithmic rules to generate a score. A binary classifier model may extract features from the match to generate a classification of match or no match and a corresponding probability of match or no match.

The interface (136) may be an application programming interface (API) or a user interface (UI) for receiving requests to match artifact identifiers to commits. The interface is further configured to respond to the requests.

The fuzzy regular expression generator (130), sorter (134), and interface (136) are connected to the comparator (132). The comparator (132) is software configured to receive the request for a matching tag, obtain an artifact version identifier regular expression from the artifact identifier fuzzy regular expression generator (130), identify matching tags, and select a top matching tag using the sorter (134). The comparator (132) is further configured to output the top matching tag.

While FIG. 1 shows a configuration of components, other configurations may be used without departing from the scope of one or more embodiments. For example, various components may be combined to create a single component. As another example, the functionality performed by a single component may be performed by two or more components.

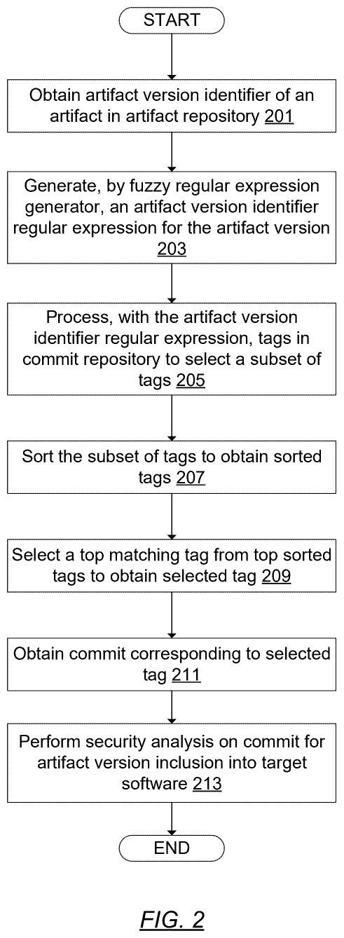

FIG. 2 shows a flowchart in accordance with one or more embodiments. The method of FIG. 2 may be implemented using the system of FIG. 1, and one or more of the steps may be performed on or received at one or more computer processors. While the various steps in this flowchart are presented and described sequentially, at least some of the steps may be executed in different orders, may be combined or omitted, and at least some of the steps may be executed in parallel. Furthermore, the steps may be performed actively or passively.

In Step 201, an artifact version identifier of an artifact in an artifact repository is obtained. For example, a security analysis of the target software may be initiated. In response to the security analysis, the artifact version identifiers referenced within or associated with the target software are obtained. For example, the artifact version identifiers may be obtained from a description of a target software or from another system. The operations of FIG. 2 may be performed for each artifact version identifier.

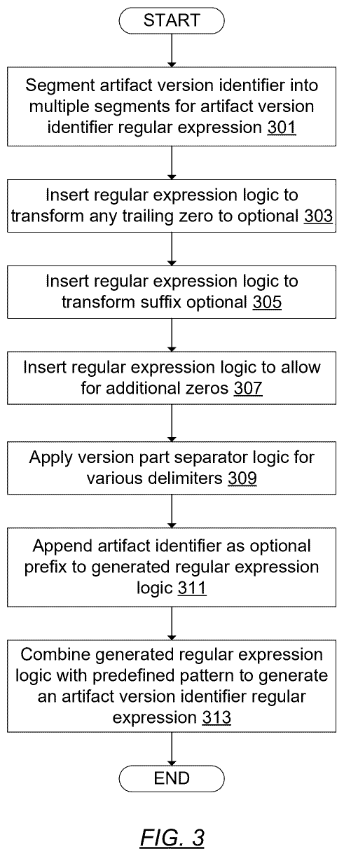

In Step 203, a fuzzy regular expression generator generates an artifact version identifier regular expression for the artifact version identifier. The fuzzy regular expression generator starts with the literal characters of the artifact version identifier and replaces some of the literal characters in the artifact version identifier with special characters. The fuzzy regular expression generator may also add special characters to make some of the literal characters optional and to allow for optional additional characters. For example, the fuzzy regular expression generator may replace the delimiters in the artifact version with alternations to allow for different types of delimiters. Similarly, the fuzzy regular expression generator may add special characters to make the name of the artifact optional if the name is present that it matches. The processing by the fuzzy regular expression generator may be performed algorithmically. An example of the processing by the fuzzy regular expression generator is presented in FIG. 3.

In Step 205, tags in the commit repository are processed with the artifact version identifier regular expression to select a subset of tags. Each of the tags in the commit repository may be processed by the comparator with the artifact version identifier regular expression. In one or more embodiments, only tags for the artifact are processed. Namely, only tags related to the various versions of the same artifact are processed. Tags that satisfy the artifact version identifier regular expression are matching tags and are added to the subset.

In Step 207, the subset of tags is sorted to obtain sorted tags. Sorting may include scoring each of the matching tags. In one or more embodiments, each of the tags are individually scored. Sorting is performed based on a comparison of the matching tags with the artifact version identifier. In one or more embodiments, the scoring is performed along a set of metrics. Some of the metrics may be definitive, while other metrics are weighted. Definitive metrics means that if one of the tags satisfy the metric, then any tag that does not satisfy the metric is excluded as being a top matching tag. If only one tag satisfies the metric, then the one tag is the top matching tag. For example, a matching suffix is a definitive metric. In the example, the suffix of the artifact version identifier and a suffix of a tag in the subset are compared to determine whether the tag has an exact matching suffix. If one or more tags have exact matching suffixes, then the remaining tags may be excluded. If one tag has an exact matching suffix, then the tag is selected as a top matching tag.

Weighted metrics are combined with other metrics to generate the score. In some cases, a metric score may be generated for the weighted metric. The metric score is then weighted and then combined with other weighted metrics to generate the score. In one or more embodiments, tags that have a longer common subsequence with the artifact version identifier have a greater metric score than the tags with a shorter common subsequence. Similarly, tags with a common prefix with the artifact version identifier have a greater metric score than tags without a common prefix. Various metrics may be used to perform the matching.

In Step 209, a top matching tag is selected from the top sorted tags. The top matching tag has the greatest score amongst the set of matching tags.

The processing of Steps 205, 207, and 209 is a two-part process. In the first part, processing the tags with the artifact version identifier regular expression serves to reduce the tags to only the tags that could match the artifact version identifier. The second part determines the best match.

In Step 211, a commit corresponding to the selected tag is obtained. The commit repository is queried with the tag to obtain the commit related to the matching tag.

In Step 213, a security analysis on the commit is performed for inclusion of the artifact version in the target software. In one or more embodiments, the state of the source code at the time of the commit is analyzed for security vulnerabilities. The source code is compared to known vulnerabilities to detect if vulnerabilities are present. For example, a security analysis program may determine whether a known malicious pattern exists. If vulnerabilities are present, a patch may be obtained for the artifact version. As another example, if the security analysis identifies a security vulnerability, then a notification may be generated to alert a user that a security vulnerability exists.

FIG. 3 shows a flowchart for processing by the fuzzy regular expression generator to generate an artifact version identifier regular expression. Turning to FIG. 3, in Block 301, the artifact version identifier is segmented into multiple segments for artifact version identifier regular expression. Segmenting the artifact version identifier includes parsing the artifact version identifiers based on common types of delimiters to generate multiple segments. The delimiters are removed. The segments are ordered according to the order in the artifact version identifier.

In Block 303, regular expression logic is inserted to transform any trailing zero to optional. If the last one or more segments according to the order are zero, special characters are added to the zeros to make the zeros optional. The special characters are regular expression logic that is added to the segments corresponding to the zeros.

In Block 305, regular expression logic is inserted to transform any suffix to optional. Special characters are added to the segment that is the suffix so that the suffix is optional.

In Block 307, regular expression logic is inserted to allow for additional zeros. The fuzzy regular expression generator adds special characters to add one or more additional zeros as regular expression logic.

In Block 309, version part separator logic is applied to allow for various delimiters. Alternation is added for each type of possible delimiter to the regular expression logic. The resulting segments are linked by the alternation.

In Block 311, the artifact identifier is appended as an optional prefix to the generated regular expression logic. Regular expression logic that identifies the artifact name or other identifier is added as being a prefix to the linked segments.

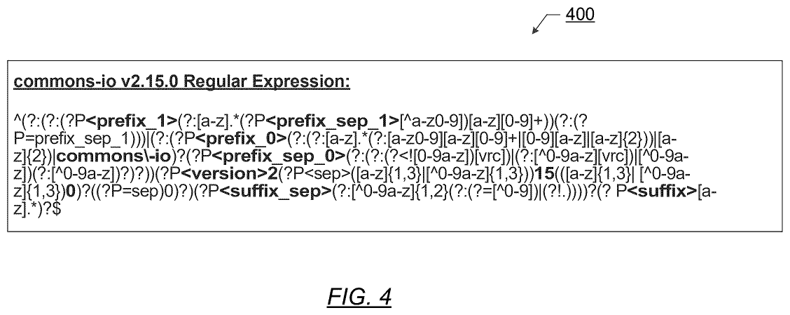

In Block 313, the generated regular expression logic is combined with a predefined pattern to generate an artifact version identifier regular expression. Predefined patterns of regular expressions may be used. Predefined patterns exist for identifying possible prefixes and prefix separators, suffixes and suffix separators, and infixes. The suffix separator detects things like a hyphen connecting the version part to the suffix. The suffix separator may be required for the suffix to be valid. The prefix separator behaves similarly except the prefix separator also catches the version characters such as “v”, “r”, and “c”. The pre-defined prefix pattern is combined with the prefix pattern that depends on the artifact identifier. The infix patterns are used to detect the delimiters between version parts. Some of these are labelled in FIG. 4.

FIG. 4 shows an example of a commons-io version 2.15.0 regular expression (400). As shown in FIG. 4, the example artifact version identifier regular expression is not for a direct matching regular expression, but rather for fuzzy matching. The fuzzy matching allows for multiple possible tags to be identified.

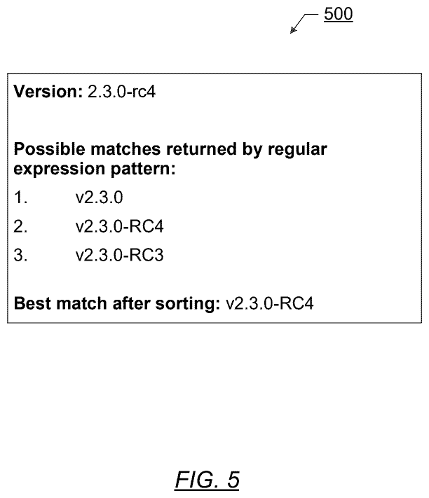

FIG. 5 shows an example of sorting of tags matched with a fuzzy regular expression generated from an artifact version identifier “2.3.0-rc4” (500). As shown in the example, multiple possible tags are deemed to match. However, the matching tag has a “v” as a prefix and capital RC4 at the end. Notably, for a human, the match may be obvious. However, a computer does not process matching the same way as a human. Because the match is inexact, without embodiments presented herein, the computer may not identify the correct artifact version identifier.

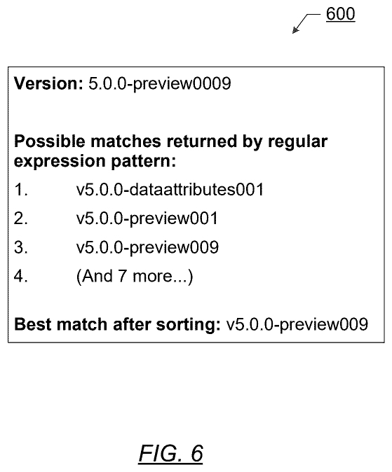

FIG. 6 shows another example of sorting tags matched with a fuzzy regular expression generated for artifact version identifier, “5.0.0-preview0009” (600). In the example, the matching tag, “v5.0.0-preview009” has an added prefix “v” and removes a zero.

As shown in the examples, the matching process using the fuzzy regular expression generator allows for variability that is specific to version identifiers. General fuzzy matching, such as those that use only Levenshtein distance, are overinclusive in matching. Such over-inclusivity may cause incorrect tags and commits to be selected as matching. By using the fuzzy regular expression generator that is specific to the variability between version identifiers, the fuzzy regular expression accommodates the variations that may exist between version identifiers that identify the same version while not allowing for variations that are uncommon. Similarly, the scoring technique is specific to the variations in version identifiers so that the tags that merely vary in nomenclature are selected rather than tags that identify a different version. The result is a more accurate selection of artifact version identification.

From a security standpoint, many software supply chain attacks exploit the fact that what is in a source code repository may not match the artifact that is actually deployed in one's system. Therefore, one or more embodiments may be used to determine if the security properties of a software component, such as build integrity, meet the expectations of a consumer. Various security analyses require that the source code repository for a given artifact be known, as well as the specific revision (commit) that best matches that artifact. It is a common assumption in security static analysis tools that the source code of a software component (artifact) is available and that it is the user's responsibility to find it or use de-compilation techniques to obtain it. These assumptions can lead to inaccurate results, as in the case of the former, it is entirely possible for a user to find the incorrect source code for their artifact, or in the case of the latter, for important security information to be lost as a result of the de-compilation. Moreover, it is not possible to recover the infrastructure code used to build and publish the artifact that is part of the source code repository by decompiling the artifact, which means vulnerabilities involving code injection during build time cannot be accounted for. Therefore, identifying the source code of an artifact is challenging.

One or more embodiments provide an end-to-end framework that automatically establishes a link from an artifact (i.e., the particular artifact version) to its source and infrastructure code, enabling downstream static analysis tools to check security properties of an artifact using techniques such as source code and build environment analysis, which can be done as soon as the artifact is published.

Namely, specific artifact versions are mapped to the exact states within the related repositories that were used to produce them, not just the related source code revision. This enables a greater degree of accuracy in supply chain security analysis in cases where the artifact is not the most recent version, (e.g., as found in the Software Bill of Materials (SBOM)). Finding the exact source code used to produce an artifact is a challenging task. Generally, released artifacts do not contain any direct link to the state of the source code repository used to build the artifact. Without a link, tags may be used. Tags are labels that can be placed on a specific commit within a repository, thereby marking the commit for a specific purpose. In an ideal case, a released artifact on a repository comes with a release tag that maps back to the relevant state of that repository, with the artifact version identifier acting as the key to the value of that mapping.

Experiments with 1900 artifacts from GitHub revealed that many tags found within repositories differ enough from the versions they are supposed to represent, that a direct comparison will not succeed. For example: one real-world artifact uses versions such as “1.2.25” while the artifact's tag is of the format “1_2_25”. Another uses versions such as “73.2” that maps to tags, such as “release-73-2”.

The processing described in one or more embodiments accommodates the different variations to provide for correct matching between artifact version identifiers and tags.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

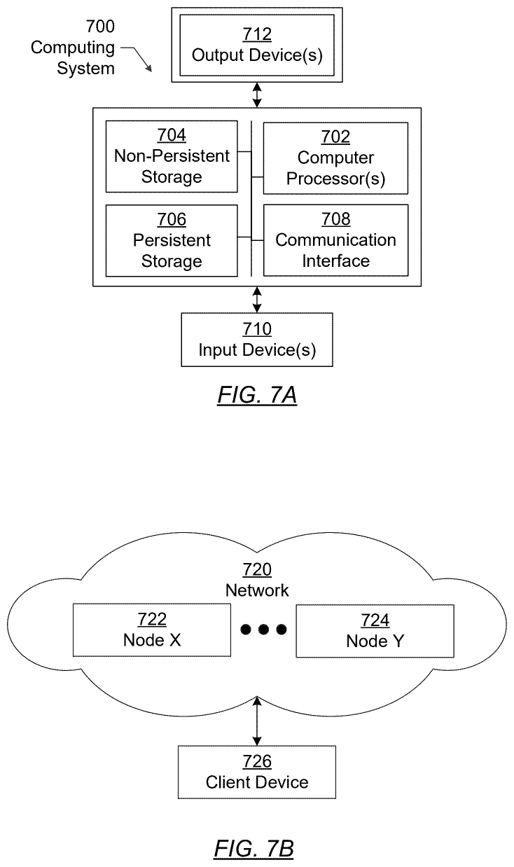

For example, as shown in FIG. 7A, the computing system (700) may include one or more computer processor(s) (702), non-persistent storage device(s) (704), persistent storage device(s) (706), a communication interface (708) (e.g., Bluetooth interface, infrared interface, network interface, optical interface, etc.), and numerous other elements and functionalities that implement the features and elements of the disclosure. The computer processor(s) (702) may be an integrated circuit for processing instructions. The computer processor(s) (702) may be one or more cores, or micro-cores, of a processor. The computer processor(s) (702) includes one or more processors. The computer processor(s) (702) may include a central processing unit (CPU), a graphics processing unit (GPU), a tensor processing unit (TPU), combinations thereof, etc.

The input device(s) (710) may include a touchscreen, keyboard, mouse, microphone, touchpad, electronic pen, or any other type of input device. The input device(s) (710) may receive inputs from a user that are responding to data and messages presented by the output device(s) (712). The inputs may include text input, audio input, video input, etc., which may be processed and transmitted by the computing system (700) in accordance with one or more embodiments. The communication interface (708) may include an integrated circuit for connecting the computing system (700) to a network (not shown) (e.g., a local area network (LAN), a wide area network (WAN) such as the Internet, mobile network, or any other type of network) or to another device, such as another computing device, and combinations thereof.

Further, the output device(s) (712) may include a display device, a printer, external storage, or any other output device. One or more of the output device(s) (712) may be the same or different from the input device(s) (710). The input device(s) (710) and output device(s) (712) may be locally or remotely connected to the computer processor(s) (702). Many different types of computing systems exist, and the aforementioned input device(s) (710) and output device(s) (712) may take other forms. The output device(s) (712) may display data and messages that are transmitted and received by the computing system (700). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disc (CD), digital video disc (DVD), storage device, a diskette, a tape, flash memory, physical memory, or any other computer readable storage medium. Specifically, the software instructions may correspond to computer readable program code that, when executed by the computer processor(s) (702), is configured to perform one or more embodiments, which may include transmitting, receiving, presenting, and displaying data and messages described in the other figures of the disclosure.

The computing system (700) in FIG. 7A may be connected to, or be a part of, a network. For example, as shown in FIG. 7B, the network (720) may include multiple nodes (e.g., node X (722) and node Y (724), as well as extant intervening nodes between node X (722) and node Y (724)). Each node may correspond to a computing system, such as the computing system shown in FIG. 7A, or a group of nodes combined may correspond to the computing system shown in FIG. 7A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (700) may be located at a remote location and connected to the other elements over a network.

The nodes (e.g., node X (722) and node Y (724)) in the network (720) may be configured to provide services for a client device (726). The services may include receiving requests and transmitting responses to the client device (726). For example, the nodes may be part of a cloud computing system. The client device (726) may be a computing system (700), such as the computing system (700) shown in FIG. 7A. Further, the client device (726) may include or perform all or a portion of one or more embodiments.

The computing system (700) of FIG. 7A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
obtaining an artifact version identifier of an artifact in an artifact repository;
generating, by a fuzzy regular expression generator, an artifact version identifier regular expression from the artifact version identifier for the artifact version;
processing, with the artifact version identifier regular expression, a plurality of tags in a commit repository to select a subset of the plurality of tags;
selecting a top matching tag from the subset; and
obtaining a commit corresponding to the top matching tag.

2. The method of claim 1, further comprising
sorting the subset based on a comparison with the artifact version identifier to obtain a sorted subset, wherein the top matching tag is selected from the sorted subset.

3. The method of claim 2, wherein the comparison comprises:
comparing a suffix of the artifact version identifier and a suffix of a tag in the subset to determine whether the tag has an exact matching suffix; and
selecting the tag as the top matching tag when the tag has the exact matching suffix.

4. The method of claim 2, wherein sorting the subset comprises:
scoring individual tags in the subset, wherein the top matching tag has the greatest score.

5. The method of claim 4, wherein the scoring comprises:
scoring individual tags in the subset to have a greater score for tags having a longer common subsequence with the artifact version identifier.

6. The method of claim 4, wherein the scoring comprises:
scoring individual tags in the subset to have a greater score for tags having a common prefix with the artifact version identifier.

7. The method of claim 1, wherein generating the artifact version identifier regular expression comprises:
segmenting the artifact version identifier into a plurality of segments for the artifact version identifier regular expression.

8. The method of claim 7, wherein generating the artifact version identifier regular expression comprises:
inserting regular expression logic into the artifact version identifier regular expression to transform any trailing zero of the artifact version identifier to optional;
inserting regular expression logic into the artifact version identifier regular expression to transform a suffix of the artifact version identifier to optional;
inserting regular expression logic into the artifact version identifier regular expression to allow for at least one additional zero;
inserting regular expression logic into the artifact version identifier regular expression to transform a suffix of the artifact version identifier to optional; and
applying, to the artifact version identifier regular expression, separator logic to allow for a plurality of different delimiters.

9. The method of claim 8, wherein generating the artifact version identifier regular expression comprises:
appending, to the artifact version identifier regular expression, a prefix of the artifact version identifier as being optional.

10. The method of claim 8, wherein generating the artifact version identifier regular expression comprises:
combining the artifact version identifier regular expression with a predefined pattern to revise the artifact version identifier regular expression.

11. A system comprising:
at least one computer processor;
a fuzzy regular expression generator configured to execute on the at least one computer processor to perform first operations comprising:
obtaining an artifact version identifier of an artifact in an artifact repository, and
generating an artifact version identifier regular expression from the artifact version identifier for the artifact version; and
a comparator configured to execute on the at least one computer processor to perform second operations comprising:
processing, with the artifact version identifier regular expression, a plurality of tags in a commit repository to select a subset of the plurality of tags,
selecting a top matching tag from the subset, and
obtaining a commit corresponding to the top matching tag.

12. The system of claim 11, further comprising a sorter configured to execute on the at least one computer processor and configured to perform third operations comprising:
sort the subset based on a comparison with the artifact version identifier to obtain a sorted subset, wherein the top matching tag is selected from the sorted subset.

13. The system of claim 12, wherein the comparison comprises:
comparing a suffix of the artifact version identifier and a suffix of a tag in the subset to determine whether the tag has an exact matching suffix; and
selecting the tag as the top matching tag when the tag has the exact matching suffix.

14. The system of claim 12, wherein sorting the subset comprises:
scoring individual tags in the subset, wherein the top matching tag has the greatest score.

15. The system of claim 14, wherein the scoring comprises:
scoring individual tags in the subset to have a greater score for tags having a longer common subsequence with the artifact version identifier.

16. The system of claim 14, wherein the scoring comprises:
scoring individual tags in the subset to have a greater score for tags having a common prefix with the artifact version identifier.

17. The system of claim 11, wherein generating the artifact version identifier regular expression comprises:
segmenting the artifact version identifier into a plurality of segments for the artifact version identifier regular expression.

18. The system of claim 17, wherein generating the artifact version identifier regular expression comprises:
inserting regular expression logic into the artifact version identifier regular expression to transform any trailing zero of the artifact version identifier to optional;
inserting regular expression logic into the artifact version identifier regular expression to transform a suffix of the artifact version identifier to optional;
inserting regular expression logic into the artifact version identifier regular expression to allow for at least one additional zero;
inserting regular expression logic into the artifact version identifier regular expression to transform a suffix of the artifact version identifier to optional; and
applying, to the artifact version identifier regular expression, separator logic to allow for a plurality of different delimiters.

19. The system of claim 18, wherein generating the artifact version identifier regular expression comprises:
appending, to the artifact version identifier regular expression, a prefix of the artifact version identifier as being optional.

20. A non-transitory computer readable medium comprising computer readable program code for causing a computer system to perform operations comprising:
obtaining an artifact version identifier of an artifact in an artifact repository;
generating, by a fuzzy regular expression generator, an artifact version identifier regular expression from the artifact version identifier for the artifact version;
processing, with the artifact version identifier regular expression, a plurality of tags in a commit repository to select a subset of the plurality of tags;
selecting a top matching tag from the subset; and
obtaining a commit corresponding to the top matching tag.
